(19) United States
(12) Patent Application Publication
(10) Pub. No.: US 2003/0009318 A1
(43) Pub. Date: Jan. 9, 2003

(54) Method of utilizing timing models to provide data for static timing analysis of electronic circuits

(75) Inventors: Matthew J. Amatangelo, Austin, TX (US); Zakaria Khwaja, Austin, TX (US); Howard Levy, Cedar Park, TX (US); Jose Angel Paredes, Austin, TX (US); Binta M. Patel, Round Rock, TX (US)

Correspondence Address: Russell D. Culbertson, Shaffer & Culbertson, L.L.P., Bldg. One, Suite 360, 1250 Capital of Texas Hwy. S., Austin, TX, 78746, US

(73) Assignee: International Business Machines Corp., Armonk, NY (US)

(21) Appl. No.: 09/888,474

(22) Filed: Jun. 25, 2001

(51) Int. Cl. G06F 17/50

(52) U.S. Cl. 703/19

(57) ABSTRACT

A timing model is constructed using a timing view of a functional component of a circuit under consideration. This timing view uses one or more timing elements to replace timing determinant blocks of the actual circuitry for the purposes of timing analysis. These timing elements represent signal delays from point to point in the circuit and relative timing between signals in the circuit, and thus represent the important timing characteristics of the actual circuitry. After creating the timing view of the circuit, a cross-section of the circuit comprising the functional component is simulated to produce values for delays and relative timing between signals in the circuit. These values from the circuit simulation are then attached to the various timing elements in the timing view to create the timing model for the portion of the circuit represented by the timing view. Static timing analysis for the overall circuit is then performed using the timing model to represent the timing characteristics of the modeled functional component.

### TECHNICAL FIELD OF THE INVENTION

This invention relates to signal timing analysis in electronic circuits. More particularly, the invention relates to a method for building very accurate timing models for complex circuitry which may be included in integrated circuit designs. The timing models produced according to the invention may be used in static timing analysis tools to provide an overall timing assessment for the complete integrated circuit design.

### BACKGROUND OF THE INVENTION

It is necessary to assess timing status within a digital circuit design in order to ensure proper circuit operation and to meet circuit frequency goals. One type of timing analysis is referred to as static timing analysis. Static timing analysis involves analyzing the behavior of a circuit at the gate or transistor level. This type of analysis is commonly conducted by software implemented tools such as the PATHMILL software by EPIC Design Technology, for example. These tools traditionally apply essentially a two-step process to perform the desired timing analysis. In the first step, the tool analyzes the behavior of the circuit under consideration on a transistor-by-transistor basis. In the second step, the tool utilizes the circuit behavior to analyze signal propagation paths and provide timing checks within the circuit. Of course, large and complex circuits require a large amount of input data. Also, the static timing analysis tools generate large amounts of data in the process of analyzing the behavior of the individual transistors or gates within the circuit under consideration. Thus, static timing analysis software tools may require excessive run times in order to analyze certain types of circuits.

In order to handle the high complexity of very large-scale integrated circuit (VLSI) designs, such as microprocessors for example, timing models are often used to abstract the timing information for particular subsections of the overall circuit or chip. These timing models for portions of the overall circuit are commonly referred to as macros and are intended to provide a succinct representation of clock and data delays between inputs, outputs, and important intermediate timing points within the portion of the circuit represented by the macro. The macros are then used in a hierarchical fashion to create a complete timing story for the overall circuit or chip.

A fundamental concern is the ability to abstract the timing paths properly in a macro so that the macro provides an accurate representation of the timing in the respective circuit portion. Providing an accurate representation is especially problematic in macros which encompass specialized logic and memory circuits. If the macros do not provide an accurate representation of the timing characteristics of the respective circuit, then the timing picture for the overall circuit will likewise be inaccurate. On the other hand, unless timing models are used to simplify the tasks which must be performed by the static timing analysis software, the timing analysis becomes overly burdensome, even for software-implemented static timing analysis tools.

One way to reduce the processing burden on a static timing analysis tool is to create special timing analysis tool commands for certain combinations of transistors or other circuit elements which may be included in an overall circuit design. These special timing analysis tool commands override the normal manner in which the static timing analysis tool treats the circuit, and thereby reduce the processing burden for the tool. A problem with this approach is that it is time-consuming to derive the forced operations to be applied to the special circuit element configurations. Also, the special treatment of certain circuit element configurations may reduce the accuracy of the timing analysis provided by the static timing analysis tool.

Another approach for reducing the processing burden on a static timing analysis tool is to build a “pseudo-circuit” of the actual circuit, the pseudo-circuit being more easily simulated by the static timing analysis tool. However, it is difficult or practically impossible to build a pseudo-circuit with the same timing characteristics as the actual circuit under consideration. A pseudo-circuit that does not have the same timing characteristics as the actual circuit can not provide the desired timing picture for the actual circuit.

### SUMMARY OF THE INVENTION

It is an object of the invention to provide a method of circuit analysis that overcomes the above-described problems and others associated with static timing analysis. The invention encompasses both a method for analyzing an electronic circuit using static timing analysis and a method for producing a timing model for use in static timing analysis.

The method of producing a timing model according to the invention includes constructing what may be referred to as a “timing view” of a functional component of a circuit under consideration. This timing view uses one or more timing elements to replace certain elements or timing determinant blocks of the actual circuitry for the purposes of timing analysis. These timing elements represent signal delays from point to point in the circuit and relative timing between signals in the circuit, and thus represent the important timing characteristics of the actual circuitry. The invention preferably includes the step of defining timing elements necessary to represent the important timing characteristics of the actual circuitry.

After creating the timing view of the circuit, the method of producing a timing model according to the invention includes simulating a cross-section of the actual circuit to produce values for delays and relative timing between signals in the circuit. These values from the circuit simulation are then attached to the various timing elements in the timing view to create the timing model for the portion of the circuit represented by the timing view. This timing model may not include actual circuit elements, but rather provides a representation of the timing characteristics of the modeled circuit.

The invention also encompasses using these timing models in static timing analysis for the circuit under consideration. Specifically, the invention encompasses performing static timing analysis for the overall circuit utilizing the timing model to replace the actual circuit portion or functional component for which the model was created. Generally, a circuit may be divided into numerous functional components which are individually modeled according to the invention. These models may then be used together by a static timing analysis tool to provide a timing assessment for the overall circuit.

As used in this disclosure and the accompanying claims, a “functional component” of a circuit comprises some portion of an overall circuit to be analyzed. For example, a functional component may comprise a section of register memory cells together with the write and read circuitry associated with the memory cells. The term “timing determinant block” is used to refer to an actual circuit element or group of elements within a functional component. In particular, a timing determinant block refers to an actual circuit element or group of elements which has an important impact on timing within the circuit functional component. For example, a memory cell itself together with a portion of the cell write circuitry may be considered a timing determinant block. The term “timing element” refers to an element according to the invention which represents the timing characteristics of a timing determinant block or a portion of such block.

The timing models created according to the invention greatly reduce the processing burden on the static timing analysis tool by eliminating a portion of the analysis otherwise performed by the tool. Specifically, the present timing models eliminate the transistor-by-transistor or gate-by-gate analysis which would otherwise be required for each transistor or gate in the portion of the circuit for which the timing model is created. This elimination of a portion of the analysis traditionally performed by the static timing analysis tool is particularly useful in timing analyses involving complex circuitry. Whenever a static timing analysis tool cannot properly analyze the propagation paths, the corresponding delays, and/or appropriate timing checks in a circuit due to the complexity of the circuit, the present invention allows the circuit to be replaced by model that represents the same timing context as does the circuit. Since the model represents the same timing context as the actual circuit, the static timing analysis tool may simply use the timing details from the model without having to derive those details itself as in traditional static timing analysis. Furthermore, the timing details provided by the model may be very accurate since they are created through a simulation of the actual circuitry represented in the model.

These and other objects, advantages, and features of the invention will be apparent from the following description of the preferred embodiments, considered along with the accompanying drawings.

### BRIEF DESCRIPTION OF THE DRAWINGS

FIG. 1 shows a representation of a delay timing element and the respective circuit elements which the delay timing element may be used to represent according to the invention.

FIG. 2 is a timing diagram showing the signal delays associated with the timing element and circuits shown in FIG. 1.

FIG. 3 shows a representation of a footed precharge timing element and a circuit which the footed precharge timing element may be used to represent according to the invention.

FIG. 4 is a timing diagram showing the signal setup and hold times associated with the timing element and circuit shown in FIG. 3.

FIG. 5 shows a representation of a latch timing element and a circuit which the latch timing element may be used to represent according to the invention.

FIG. 6 is a timing diagram showing the signal setup and hold times associated with the timing element and circuit shown in FIG. 5.

FIG. 7 shows a representation of a gated clock timing element and a circuit which the gated clock timing element may be used to represent according to the invention.

FIG. 8 is a timing diagram showing the signal setup and hold times associated with the timing element and circuit shown in FIG. 7.

FIG. 9 shows a representation of an unfooted precharge timing element and a circuit which the unfooted precharge timing element may be used to represent according to the invention.

FIG. 10 is a timing diagram showing the signal setup and hold times associated with the timing element and circuit shown in FIG. 9.

FIG. 11 is a block circuit diagram showing an example prior art register file cell arrangement.

FIG. 12 is a circuit diagram showing a prior art register file cell.

FIG. 13 is a circuit diagram of one of the read multiplexers shown in FIG. 11.

FIG. 14 is a timing view of the circuit shown in the block diagram of FIG. 11.

FIG. 15A is a gray box representation of prior art memory array.

FIG. 15B is a timing view of the memory array shown in FIG. 15A.

FIG. 16 is a flow chart showing the method steps according to the present invention.

### DESCRIPTION OF THE PREFERRED EMBODIMENTS

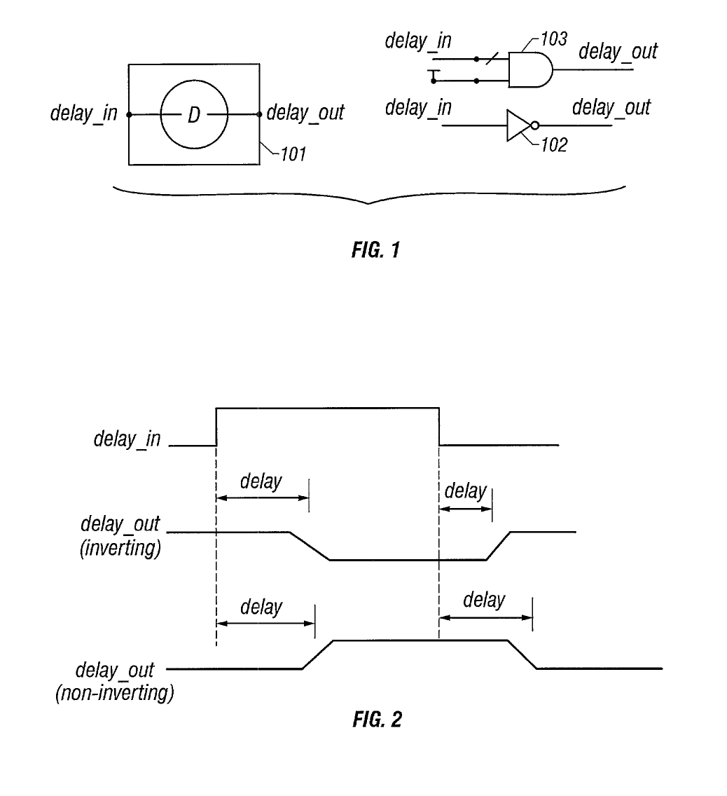

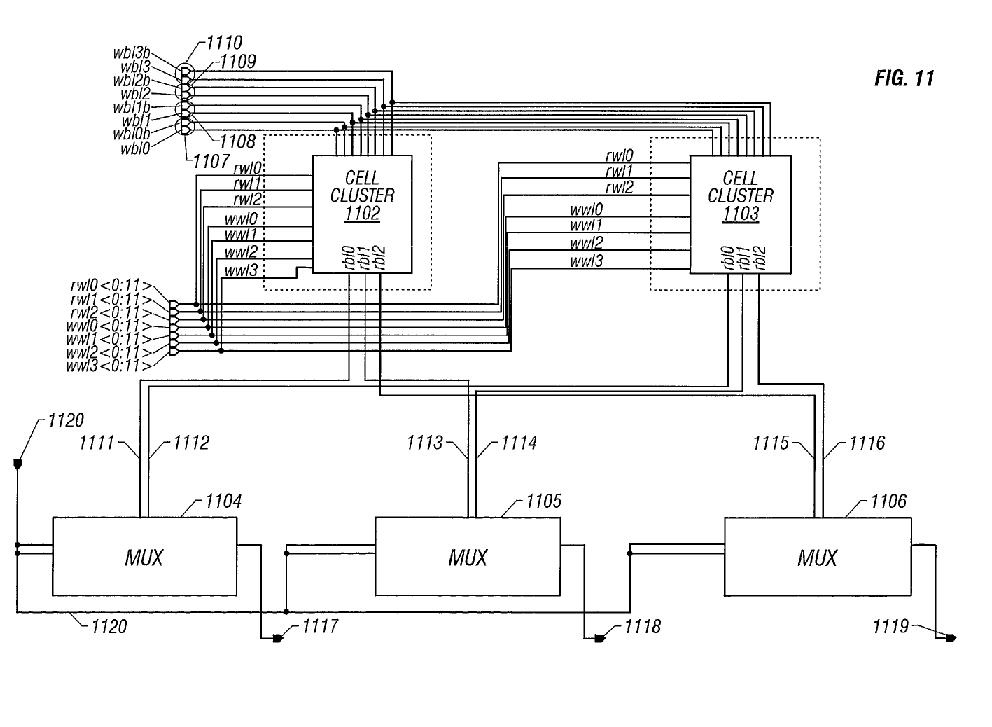

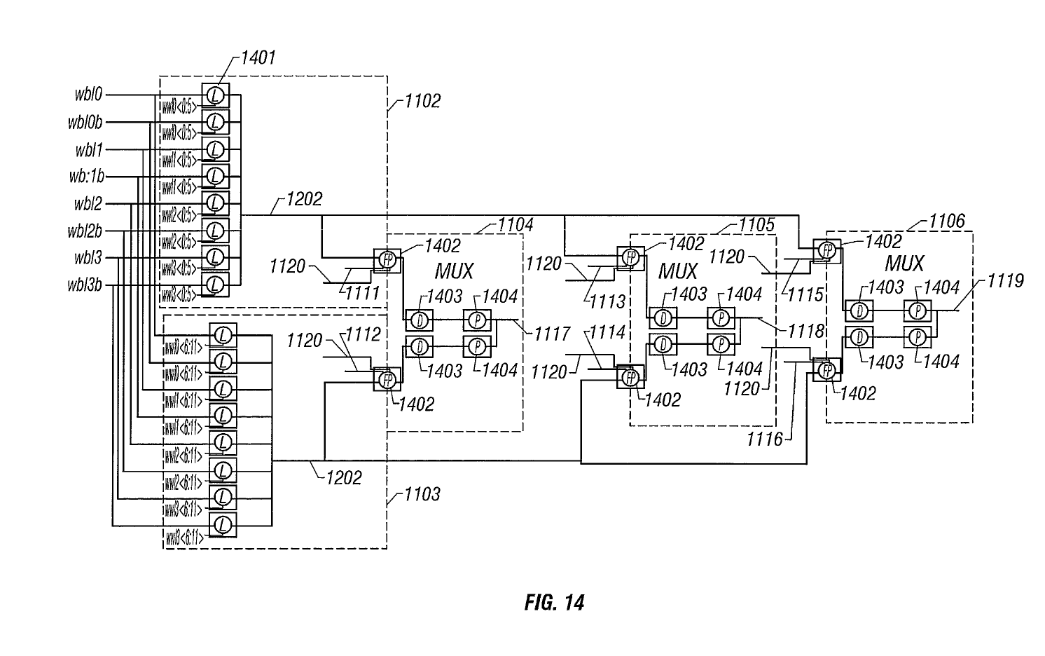

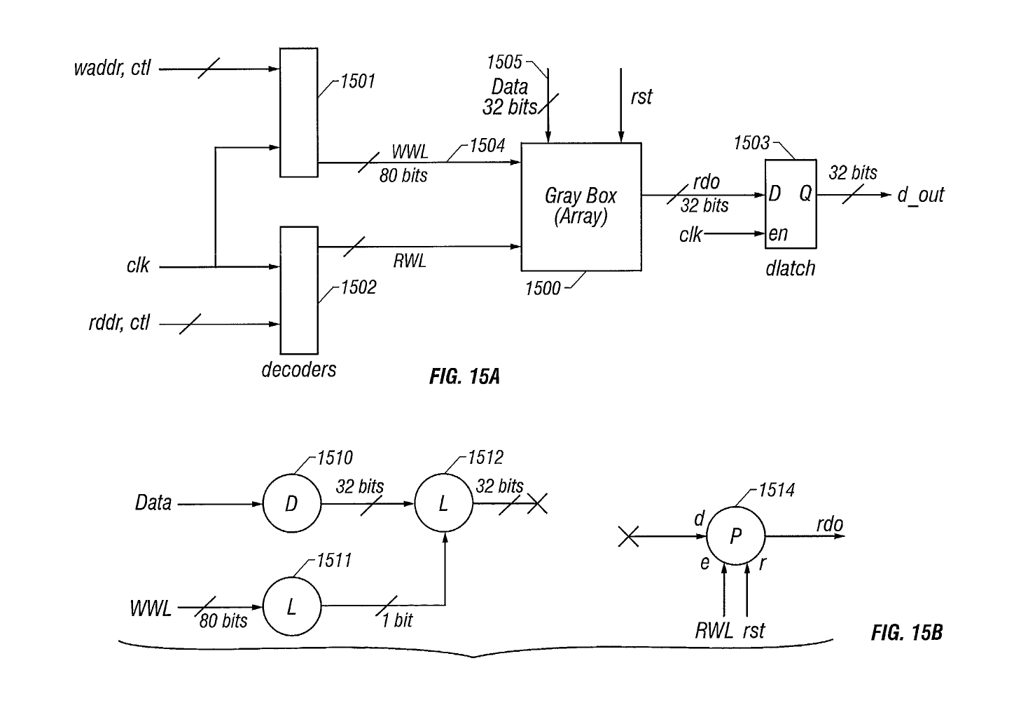

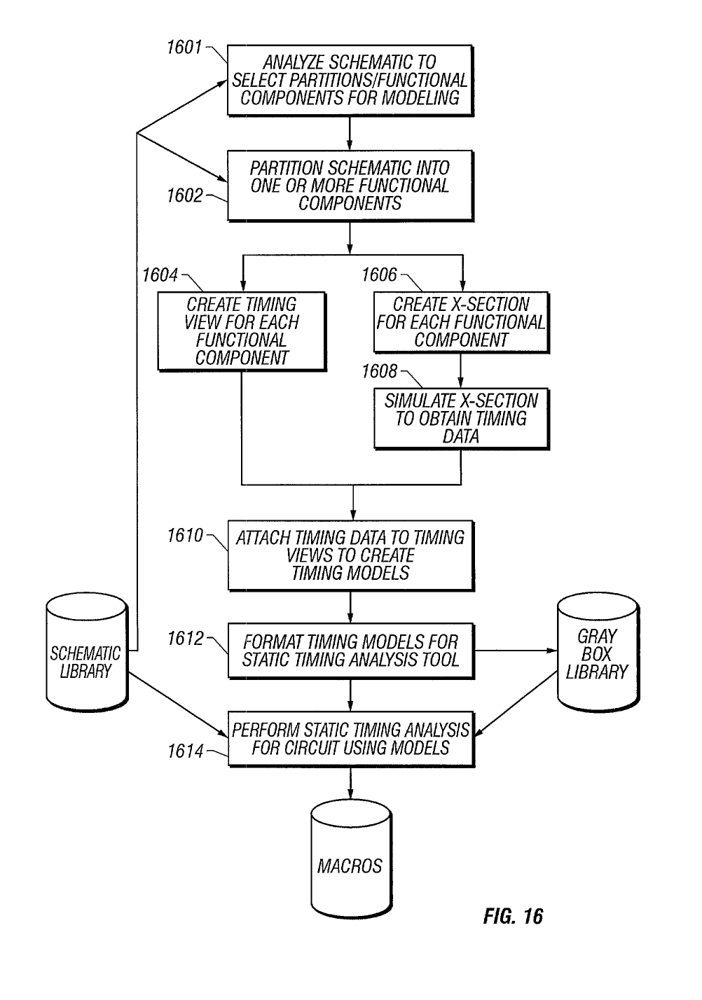

The invention may be described with reference to example circuitry shown in FIGS. 11 through 13, and 15A, and with reference to the flow chart shown in FIG. 16. Timing views of the example circuits are shown in FIGS. 14 and 15B. The basic timing elements necessary to create these timing views according to the invention will first be described with reference to FIGS. 1 through 10.

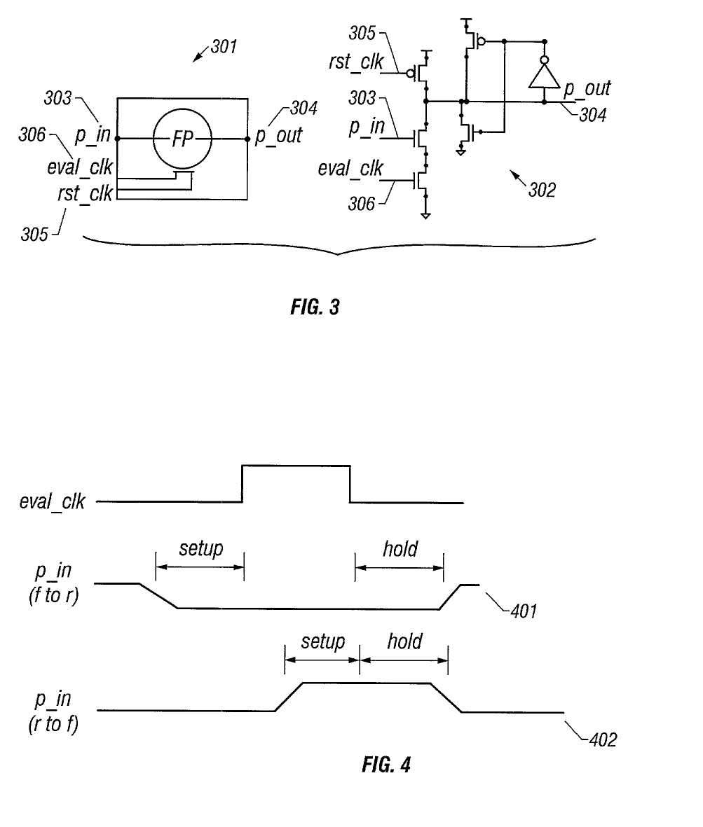

The present invention utilizes a number of basic timing elements which are pieced together to represent the timing in a circuit, particularly a circuit which may be difficult for a static timing analysis tool to analyze. The types of timing elements used according to the invention will depend upon the circuitry to be modeled. At the very least, a timing element must be available to represent the propagation delay within the circuitry to be modeled. Such a delay timing element will be described below with reference to FIGS. 1 and 2. Also, if the circuit to be modeled includes clock signals, a timing element must be available to represent the time relationship between input and output signals and the clock or clocks. Furthermore, if the relationship between clocks and data requires that the propagation to the next clock/data checkpoint be dependent on the arrival time of the data to the prior clock/data checkpoint, then the group of timing elements available for creating the timing view according to the invention must also be able to represent this dependency between timing checkpoints in the circuitry. FIGS. 3 through 8 show timing elements which may be used to represent the relative timing between clock and data signals in certain circuits.

Table 1 lists a group of timing elements for one example of the present invention. Timing elements 1 and 2 in Table 1 represent delay elements for clock and data signals respectively, and will be described further below with reference to FIGS. 1 and 2. As indicated in Table 1 and as shown in FIG. 1, these two elements each have a single source or input node and a single output or sink node. Of course, the node type remains consistent between source and sink node for each element.

The delay timing element 101 in FIG. 1 may be used according to the invention to describe a signal propagation delay. For purposes of example, FIG. 1 shows that the delay may be associated with an inverter 102 or an inverting gate 103. It will be appreciated that these schematic elements are shown only for purposes of example and that the delay timing element 101 may be used to represent the delay associated with any static gate. FIG. 2 shows the propagation delay which may be associated with the delay timing or both inverted and non-inverted output signals.

TABLE 1

| Timing Element | | | Timing Element |
|---|---|---|---|
| No. | Source Node(s) | Sink Node | Type |
| 1 | clock | clock | delay |
| 2 | data | data | delay |
| 3 | clock, data | data | footed precharge |
| 4 | clock, data | data | latch |
| 5 | clock, data | clock | gated clock |
| 6 | clock, data | data | unfooted precharge |
| | | | input without |
| | | | precharge clock and |
| | | | latch |

Timing elements 3 through 6 in Table 1 each include two source nodes and a single sink or output node, and are used to represent relative timing between clock and data signals. Timing element 3 represents the timing relationship in a footed precharge circuit and is the subject of FIGS. 3 and 4. Referring to FIG. 3, the timing element 301 for the footed precharge includes a node connection for each node having timing significance in the actual footed precharge circuit 302 shown on the right hand side of FIG. 3. It will be noted that timing element 301 eliminates the actual devices used to make up the circuit which the timing element is intended to represent and instead shows only the precharge in and out nodes, 303 and 304 respectively, along with the reset clock node 305 and evaluation clock node 306, so that the element may represent the timing between signals at these nodes. FIG. 4 illustrates the setup and hold times for a falling to rising precharge-in signal at line 401 and the setup and hold times for a rising to falling precharge-in signal at line 402. The setup time represents a minimum allowable time between the leading edge of the respective precharge signal and the respective edge of the evaluation clock signal at evaluation clock node 306. The hold time represents a minimum value of time after the evaluation clock signal falls during which the precharge signal must be held.

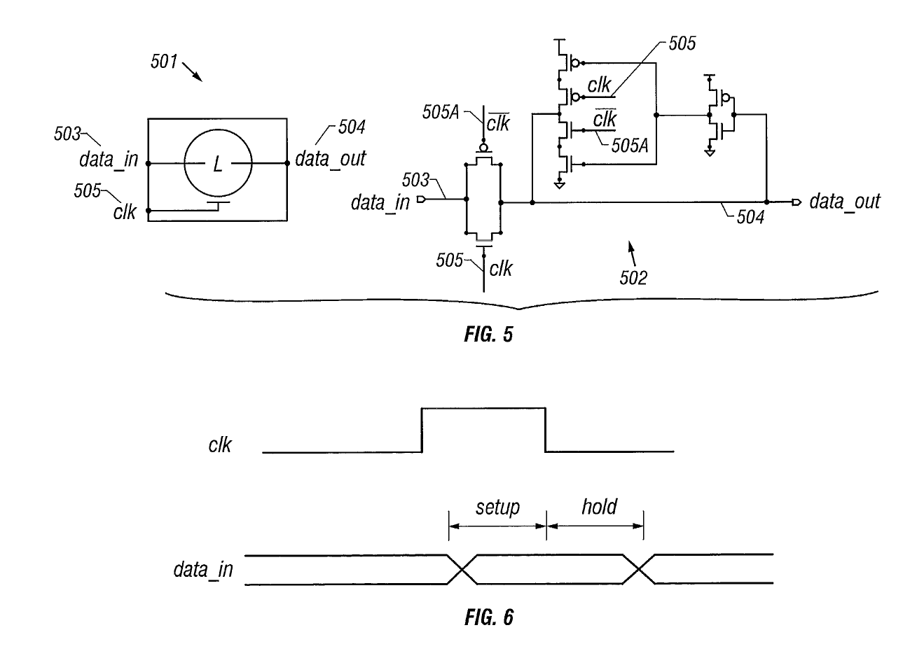

Timing element 4 in Table 1 represents the timing relationship in a latch circuit and is the subject of FIGS. 5 and 6. Referring to FIG. 5, the latch timing element 501 according to the invention is used to represent the timing context or characteristics of a latch circuit 502. Again, it will be noted that timing element 501 omits the various circuit elements and is concerned only with the relative timing of signals to and from the actual circuit. In particular, latch timing element 501 shows a data in node 503, data out node 504, and a clock node 505 (the complementary clock signal at node 505A in the actual circuit 502 being neglected for purposes of timing analysis). FIG. 6 shows the timing between the data in to the latch at node 503 and the clock signal at node 505. The setup time represents the minimum allowable time that the data must be present before the fall of the clock signal, while the hold time represents the minimum allowable time that the data must be present after the fall of the clock signal.

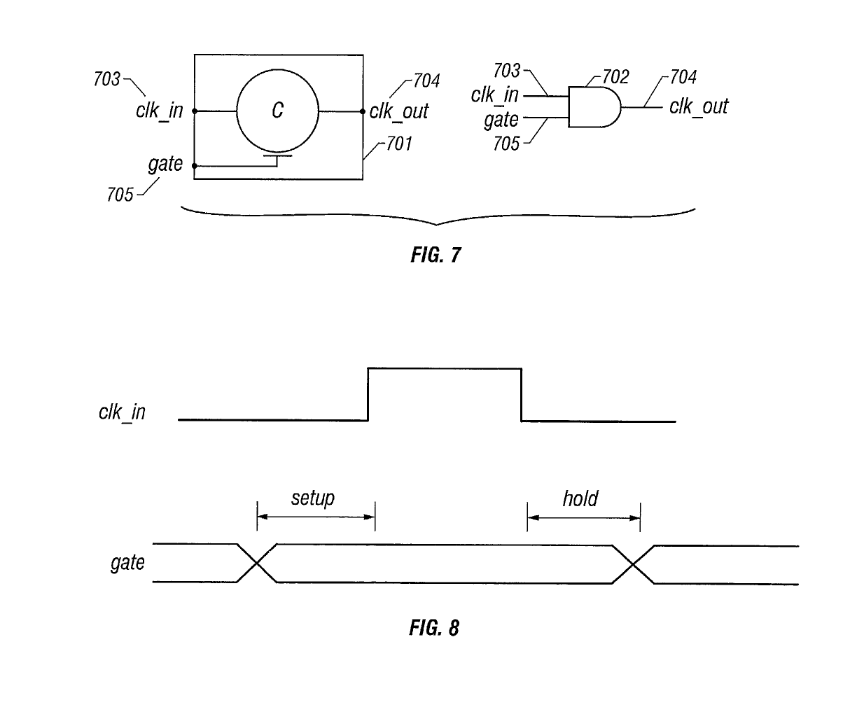

Referring back to Table 1, timing element 5 represents the timing relationship in a gated clock circuit. Such a gated clock circuit and its timing view representation according to the invention are shown in FIG. 7. In particular, the timing element of the gated clock is shown at 701 in FIG. 7, while the actual circuit is shown at 702 in block diagram form. Once again, the timing element is concerned only with the timing-related nodes of the actual circuit, in this case clock in node 703, clock out node 704, and gate node 705. FIG. 8 shows the timing relationship between the clock in signal at node 703 and the signal at the gate node 705, and particularly the allowable setup and hold times for the gate signal with respect to the clock signal.

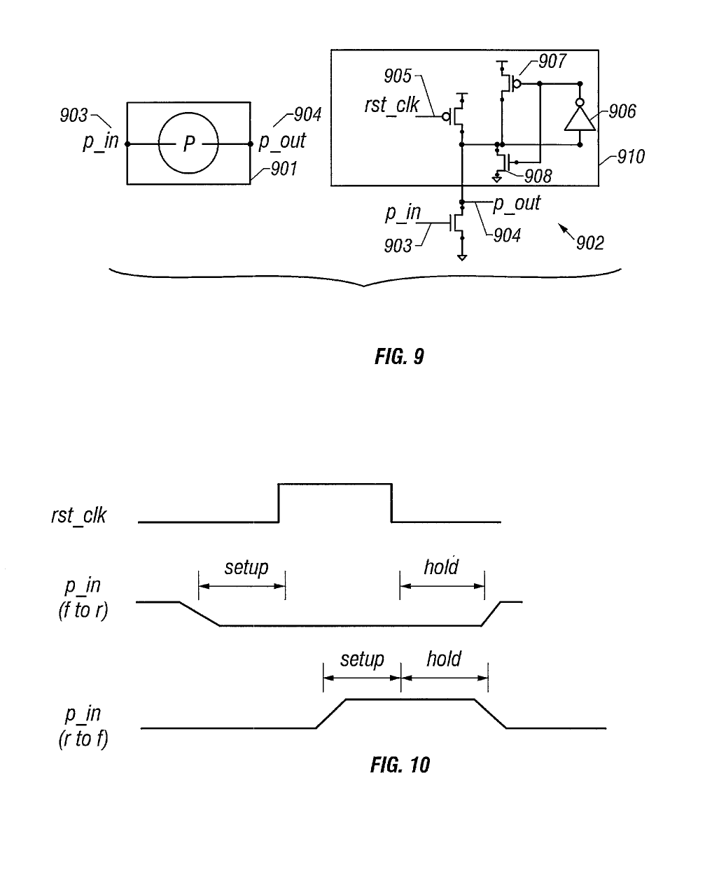

Timing element 6 in Table 1 represents the timing relationship of an unfooted precharge input. It will be noted that timing element 6 does not include the precharge clock and latch associated with the unfooted precharge circuit. Omitting the precharge clock and latch associated with the unfooted precharge circuit is a matter of partitioning and accommodates sharing the precharge node among multiple models. FIG. 9 shows a timing element representation 901 of the unfooted precharge circuit along with the actual circuit diagram 902 for the unfooted precharge circuit. The timing element is concerned only with the relative timing of the precharge in and out signals and thus includes only a precharge in node 903 and a precharge out node 904. It will be noted that the reset clock transistor 905, the inverter 906, and feedback transistors 907 and 908 shown in box 910 are not included in this timing element as a matter of partitioning. Referring to FIG. 10, the setup and hold times are shown for both the falling to rising and rising to falling precharge in signal with respect to the reset clock for the unfooted precharge circuit.

The timing elements shown in Table 1 represent the basic elements needed to define timing in many types of circuits. It will be appreciated that more variety could be added within the scope of the present invention. For instance, the footed precharge and latch elements included in Table 1 are concerned only with high-true active clock signals (transparent during clock-high time). However, similar elements could be created for low-true active clock signals. Variety could also be added to the basic precharge element in a number of ways. For example, a timing element within the scope of the invention could have common precharge and evaluation clocks, separate precharge and evaluation clocks, no evaluation clock (footless domino), or no precharge clock (the precharge transistor not included in the timing element). Furthermore, where the designer is only interested in propagating the clock signal edges, a precharge timing element may include no data input.

FIGS. 11, 12, and 13 provide an example of a register file circuit 1101 to which the present invention may be applied. These sort of register file circuits are difficult for a static timing tool to analyze in the traditional fashion. In particular, the complexity of the register file circuit requires excessive amounts of data in traditional static timing analyses, resulting in excessive run times for the static timing analysis tool.

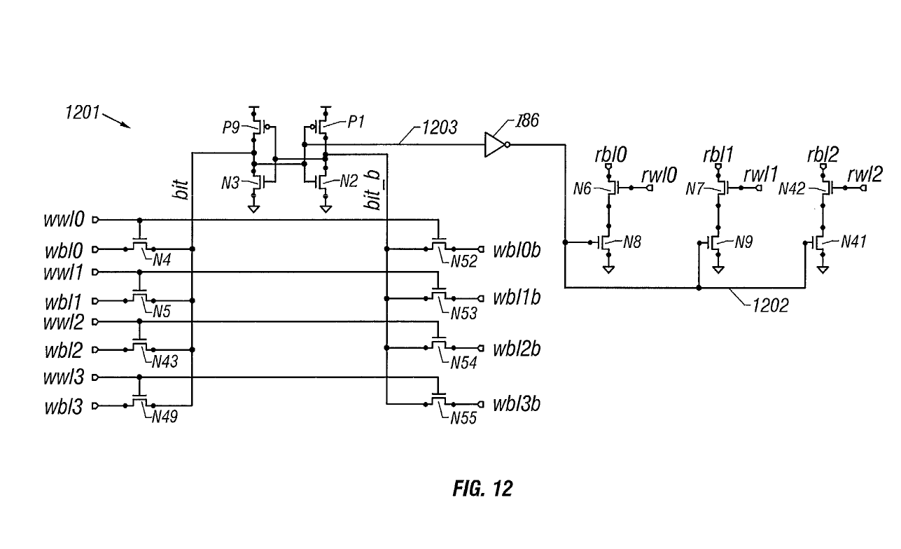

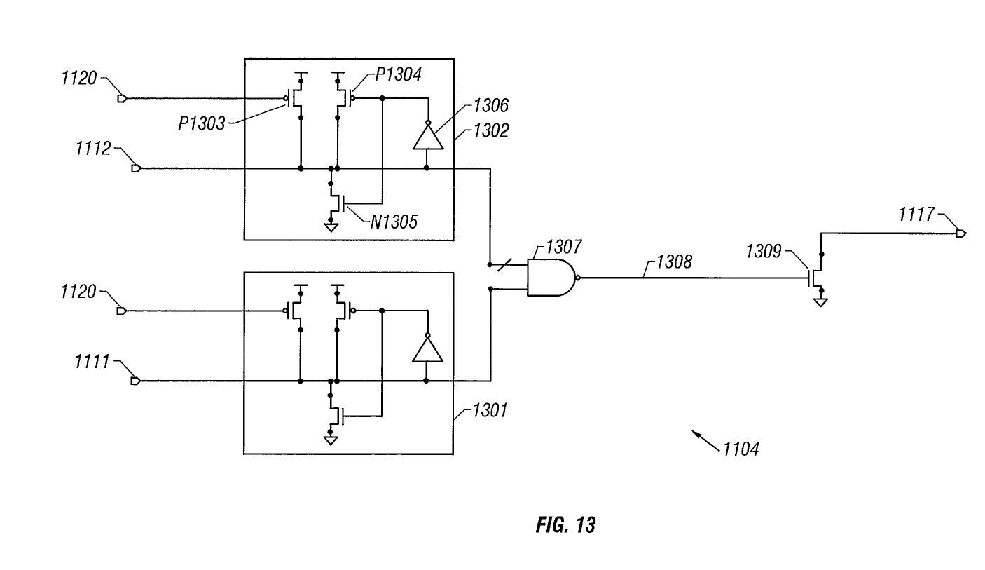

FIG. 11 comprises a high-level block diagram with two clusters of register file cells, cell cluster 1102 and cell cluster 1103. Each cell cluster 1102 and 1103 includes six individual register file cells. The individual cells will be described below with reference to FIG. 12. The memory cells are read through the three read multiplexers 1104, 1105, and 1106. The read multiplexers will be described with particular reference to the FIG. 13.

Referring to FIG. 12, each memory cell 1201 includes four differential write ports, each port associated with a complementary pair of bit lines. The signals at write bit lines wb10, wb11, wb12, and wb13 represent data and the signals at the write bit lines wb10b, wb11b, wb12b, and wb13b represent the complements to the respective data. A series of N-type transistors N4, N5, N43, and N49, connect the true data write bit lines wb10, wb11, wb12, and wb13 to the input or latch node “bit” of memory cell 1201, while transistors N52, N53, N54, and N55 connect the complementary write bit lines to the input or latch node “bit_b” of the memory cell. Transistors N4 and N52 are controlled by signals on the write word line ww10 to provide a first write data port, while transistor pairs N5 and N53, N43 and N54, and N49 and N55 are controlled by the signals on write word lines ww11, ww12, and ww13, respectively to provide the second, third, and fourth write ports. The write word line signals represent clock signals for the purposes of this example. It will be appreciated from FIG. 12 that the four write ports are exclusive. That is, only one write port may be active at any given time to write data to cell 1201.

Memory cell 1201 comprises a cross coupled memory latch made up of the devices P9 and N3 on one side and P1 and N2 on the opposite side. The output of memory cell 1201 is shown at node 1202. An inverter I86 is interposed between a cell internal node 1203 and cell output node 1202.

Data is read from cell 1201 through three dynamic read ports shown at read bit lines rb10, rb11, and rb12 in FIG. 12. These read bit lines are precharged prior to a read operation as will be discussed below with reference to the multiplexer shown in FIG. 13. Each read port is associated with a read word line transistor and a read transistor. Specifically, read bit line rb10 is associated with read word line transistor N6 and read transistor N8, read bit line rb11 is associated with read word line transistor N7 and read transistor N9, and read bit line rb12 is associated with read word line transistor N42 and read transistor N41. Cell output node 1202 is connected to the gates of the three read transistors N8, N9, and N41. These N-type transistors N8, N9, and N41 form footer devices for the respective read ports. Read word lines rw10, rw11, and rw12 are connected to the gates of the three word line transistors N6, N7, and N42, respectively. The read operation at each output port is controlled through the signals at the respective read word lines. Similar to the write word line signals, the signals at these read word lines rw10, rw11, and rw12 represent clock signals for the purposes of the present invention.

In operation, the true data signal from cell 1201 at internal node 1203 is inverted at inverter I86 and applied to cell output node 1202. A high level inverted data signal at node 1202 places the read transistors N8, N9, and N41 in a conductive state, while a low level inverted data signal places the read transistors in a non-conductive state. Each read bit line rb10, rb11, and rb12 is precharged to a logical high level prior to a read operation. The read operation at each read port is then controlled by the word line signals at rw10, rw11, and rw12, respectively. A high level word line signal prompts a read operation through the respective port by placing the respective read word line transistor N6, N7, and N42 is a conductive state. Thus, a high level inverted data signal at cell output port 1202 and a high level read word line signal at the respective read word line transistor allows the respective read bit line to drop to a low level through the two N-type transistors, and this low level signal represents the true data from memory cell 1201. In contrast, a low level inverted data signal at cell output node 1202 turns off the read transistors N8, N9, and N41, causing the respective read bit line to remain high when the respective read word line transistor is active. This high level signal at the read bit line represents the true data from memory cell 1201. It will be appreciated that the read ports may simultaneously read data from the memory cell 1201.

It will be apparent now referring back to the high-level block diagram of the FIG. 11 that the memory cells in each of the two cell clusters 1102 and 1103 share the four differential write ports indicated at reference numerals 1107, 1108, 1109, and 1110. Also, each of the three read ports rb10, rb11, and rb12 are common to each of the six memory cells in each cluster of cells. For the two clusters of six memory cells each, this forms six cluster output nodes 1111, 1112, 1113, 1114, 1115, and 1116, each a precharge node and output for the respective footed precharge gates for the two clusters of memory cells 1102 and 1103. The signals at cluster output nodes 1111 and 1112 are multiplexed through read multiplexer 1104. Similarly, the signals at cluster output nodes 1113 and 1114 are multiplexed through read multiplexer 1105 and the signals at nodes 1115 and 1116 are multiplexed through read multiplexer 1106. The desired data read from the various memory cells appears at mux output 1117 for multiplexer 1104, mux output 1118 for multiplexer 1105, and mux output 1119 for multiplexer 1106. Each of the read multiplexers 1104, 1105, and 1106 are connected to a common precharge node 1120.

FIG. 13 shows details of one of the read multiplexers. Read multiplexer 1104 is shown for purposes of example, although it will be appreciated that each read multiplexer has the identical structure. As shown in FIG. 13, the multiplexer circuitry includes a precharge and latch 1301 for cluster output node 1111 and a precharge and latch 1302 for cluster output node 1112. The two in precharge and latch circuits 1301 and 1302 are identical and include a precharge P-type transistor P1303, pull-up and pull-down transistors P1304 and N1305, respectively, and a feedback inverter 1306. The outputs of the two precharge and latch circuits 1301 and 1302 provide inputs to BAND gate 1307. The output of BAND gate 1307 at internal node 1308 is connected to the gate of N-type output transistor 1309 having a drain terminal connected to multiplexer output 1117. It will be noted that the precharge signals from node 1120 to the precharge and latch circuits 1301 and 1302 represent clock signals.

FIG. 14 shows a timing view according to the present invention for the actual register file circuit described above with reference to FIGS. 11 through 13. In this timing view, each of the timing determinant elements in the actual circuit are replaced with one or more appropriate timing elements. These timing elements are described in Table 1 and FIGS. 1 through 10. In this timing view according to the invention, the write ports for the two memory cell clusters 1102 and 1103 are represented using latch elements 1401 where 1202<0:5> are the outputs of the latch nodes of cell cluster 1102 and 1202<6:11> are the outputs of the latch nodes of cell cluster 1103. These latch elements check the setup and hold time for the data in to the respective port with respect to the clock. In this case the clock is the signal at the write word lines wow 0, ww11, ww12, and ww13 for the respective memory cells. These are shown as ww10 to 3<0:5> and ww10 to 3<6:11> in the timing view. Comparing the timing view of FIG. 14 to the circuit diagrams of FIGS. 11 and 12, it will be appreciated that the latch timing elements 1401 are used to represent the timing characteristics associated with the actual write port circuitry and memory cell circuitry through to the output nodes 1202 of the cells. Since the writes are differential, a latch timing element 1401 is included for each of the true bit lines and each of the complementary bit lines.

In the timing view shown in FIG. 14, each footed precharge timing element 1402 represents the aggregate precharge circuitry associated with the memory cell clusters 1102 and 1103 and the respective read multiplexer 1104, 1105, and 1106. This precharge circuitry consists of the precharge transistor P1303, full latch comprising devices P1304, N1305 and inverter 1306 of the respective read multiplexer shown in FIG. 13, plus the evaluation transistors associated with the three read bit lines of each memory cell (either N8 and N6, or N9 and N7, or N41 and N42 shown in FIG. 12). This aggregate footed precharge timing element is used to check setup and hold time for arriving data at nodes 1202 with respect to the precharge clock represented by the signal at node 1120 and the evaluation clock represented by the signal at the respective read word line (rw10, rw11, and rw12 in FIG. 12).

The BAND gate 1307 shown in FIG. 13 inside the respective read multiplexer is represented in the timing view of FIG. 14 with a delay timing element 1403 such as the delay element shown in FIG. 1. Lastly, the read multiplexer output transistor 1309 (FIG. 13) for each read mux is represented by an unfooted precharge timing element without precharge clock and latch. This type of timing element according to the invention is described with reference to FIGS. 9 and 10 above.

Several characteristics of timing views according to the present invention will be apparent by comparing the actual circuit schematics of FIGS. 11 through 13 to the timing view of FIG. 14. First, the timing view includes only timing elements required to represent the timing characteristics or context of the actual circuit and provide the desired timing checks within that circuit. This greatly simplifies the circuit to include only information relevant to timing analysis. Second, since the timing analysis is concerned with signal propagation paths, timing elements according to the invention must be inserted for each path to be considered. This may result in multiple timing view elements to represent a single circuit element or group of elements. For example, since multiplexed signals share the same propagation path out of the read multiplexers 1104, 1105, and 1106, two delay timing elements 1403 are shown in FIG. 14 for the single BAND gate 1307 shown in FIG. 13 and two unfooted precharge timing elements 1404 are shown for the single output transistor 1309 in FIG. 13. The dual paths in the timing view represent the signal paths of the two multiplexed signals through the respective multiplexer.

It will be appreciated that the timing view of FIG. 14 is shown only for purposes of example. Depending upon the signal timing to be checked, it is possible to prepare a different timing view for the same circuit.

FIGS. 15A and 15B may be used to illustrate how the present invention may be utilized to reduce analysis effort and data size in static timing analysis. FIG. 15A comprises a block diagram of a memory array 1500 with write and read decoders 1501 and 1502. Write decoder 1501 generates write word line signals to write to the desired memory cells in memory array 1500, and read decoder 1502 generates read word line signals to address the desired memory cells for read operations. An output latch 1503 is also associated with memory array 1500. The width of the write word line bus 1504 to array 1500 is 80 bits, and the data bus 1505 is 32 bits wide. In this example the memory arrangement delivers a 32-bit output at d_out from an array containing 80 entries, each entry 32 bits deep.

FIG. 15B comprises a timing view of this memory array and associated circuitry. In the timing view a delay element 1510 is used to represent the delay of the data into the memory array 1500. The timing view uses a latch timing element 1511 to represent the write word line decoder timing characteristics and a second latch timing element 1512 to represent the write timing characteristics associated with the memory array 1500. The timing view also uses a precharge timing element 1514 to represent the read timing characteristics associated with array 1500.

It will be noted that the 80 bit write word line bus 1504 may be reduced through the latch element 1511 to a single signal. This has the effect of cutting the timing paths by a factor of 80. Reducing the timing paths in this fashion is possible because the circuit designer may identify and control by design the worst case situation of the decoder to cell and cell to output. Thus, the circuit may be simulated according to this worst case scenario. Alternatively, the best and worst case delays may be modeled by reducing the write word line bus down to two signals representing the timing paths for each physical corner of the array. The read word line bus (not shown in FIG. 15B) could also be reduced in order to abbreviate the number of read paths which must be analyzed.

With this background regarding timing elements and timing views according to the invention, the overall circuit analysis process according to the invention may now be described with reference to the flow chart of FIG. 16. The process begins with a consideration of the top level schematic diagram for the circuit to be analyzed as shown at process block 1601, and then a partitioning of the circuit as shown at process block 1602 based on this initial consideration. The goal of the initial consideration of the circuit schematic is to identify functional components of the circuit which should be modeled according to the invention. The actual partitioning of the circuit into these identified functional components is shown at the separate step 1602.

It will be appreciated that portions of the circuit to be analyzed may be included in a timing model according to the invention and other portions of the circuit may be analyzed in the traditional fashion by the static timing analysis tool. Generally, the designer would select the boundaries for timing views and the resultant models according to the invention based at least partially on the relative ease or difficulty of analyzing the circuit portions through traditional techniques. In particular, it would be preferable to select timing views to reduce the complexity of the circuit left for traditional static timing analysis in order to reduce processing time or reduce data volume. It is also preferable to include in the timing models those portions of the circuit that are recognized as being difficult for the static timing analysis tool to handle. These functional components of a circuit include RAMS, differential write circuitry, and some dynamic circuit structures.

Once the actual schematic diagram for the circuit under consideration is partitioned to isolate the desired functional components, the method branches into two paths which may be performed simultaneously. In one process path, the method next includes creating a timing view for each functional component to be modeled according to the invention to reduce the processing burden on the static timing analysis tool. This step is shown at process block 1604 in FIG. 16 and includes replacing at least one and commonly several timing determinant blocks of circuit elements in the functional component with a set of appropriate timing elements. These timing elements are selected from a group of elements such the timing elements described above with reference to FIGS. 1 through 10. The invention encompasses the step of creating a group of these timing elements suitable for representing various circuitry in a function component. The timing view will take into consideration a number of timing aspects of the circuitry being modeled. For example, the timing view for a functional component will take into account what reference launched the input data to the functional component and what reference captures the output data from this functional component. The timing view will also be constructed considering what timing checks need to be performed to ensure that the actual circuit meets timing requirements.

The step of producing a timing view is described above with reference to FIGS. 11 through 14. In that example, the functional component is taken as the cell clusters 1102 and 1103, along with the read multiplexers 1104, 1105, and 1106 in FIG. 11. Timing dependent blocks within this functional component are replaced or represented by timing elements to produce the timing view shown in FIG. 14.

In some cases the actual circuitry or timing determinant block will be replaced with a set of timing elements consisting of a single timing element. For example, referring to FIGS. 11, 12, and 14, the write circuitry and memory cell 1201 shown in FIGS. 11 and 12 are represented by a latch timing element 1401 in the timing view of FIG. 14 (actually two such timing elements 1401, one for each differential write signal). The four sets of latch timing elements in FIG. 14 for each cell cluster are necessary to represent the four different differential write paths to a respective memory cell in the cluster. In other cases, a set of multiple timing elements will be necessary to represent the timing characteristics of the timing determinant block. An example of this situation is seen in the read multiplexers 1104, 1105, and 1106 described with reference to FIGS. 11 and 13, and the timing view representation of these timing determinant blocks shown in FIG. 14. Portions of the multiplexers are represented in the timing view with a delay element 1403 and a precharge element 1404 for each data path through the respective multiplexer. Thus, the timing determinant block in this case is replaced with a set containing more than one timing element. In other cases the set of timing elements used to replace a timing determinant block may include only a single timing element.

It will also be noticed from FIGS. 11 through 14 that a single timing element may be used to represent portions of different timing determinant blocks in the timing view. This situation is shown in FIG. 14 where the footed precharge timing elements 1402 are used to represent the timing characteristics of the aggregate precharge circuitry associated with the memory cell read circuitry shown in FIG. 12 and the multiplexer precharge circuitry shown in FIG. 13.

The second process branch shown in FIG. 16 includes first the step of creating or identifying a cross section of the circuit comprising each functional component which has been isolated or partitioned at step 1602. This cross section creation or identification step is shown at process block 1606 in FIG. 16. Preferably, the cross section is selected according to some goal for the timing model. As discussed above with reference to FIGS. 15A and 15B for example, the cross section may be selected to represent the worst case timing path according to the physical layout of the functional component. Also, multiple cross sections may be selected to represent worst and best case timing paths for example.

Once the cross section or cross sections of the functional component are selected, the method includes simulating the selected cross section or cross sections of the circuit. This simulation step is shown at process block 1608 in FIG. 6 and may be performed in any suitable fashion, and preferably with a suitable circuit simulation tool. The purpose of this simulation step is to obtain timing values for the various inputs, outputs, and clocks of the various timing view elements.

The two branches combine again at process block 1610 in FIG. 16. At this step, the circuit analysis method according to the invention includes adding or attaching the timing values obtained from the circuit simulation to the timing view elements to create a gray box timing model for the respective function component. For example, the simulation of the circuit shown in FIG. 11 will produce a characteristic delay for the BAND gate (FIG. 13). This characteristic delay is attached according to the invention to the delay element 1403 shown in FIG. 14. As another example, the circuit simulation will create a characteristic timing between the data in signals at the write bit lines, the write word line clock signals, and the data out from a respective memory cell 1201 appearing at node 1202 in FIG. 12. This data and clock signal information from the simulation may be attached according to the invention to the write latch elements 1401 in the timing view of FIG. 14.

The process also preferably includes formatting the resulting gray box models produced according to the invention. This formatting step is shown at step 1612 in FIG. 16, and is required in order to place the model information in a form usable by the particular static timing analysis tool to be used in performing the static timing analysis. The invention also preferably includes storing these gray box models, preferably in formatted form, in a gray box library for use by a static timing analysis tool as described below. It will be appreciated that the particular format of model information is dependent upon the static timing tool to be used in performing the actual static timing step according to the invention. The invention encompasses placing the model information in any format as required by the selected static timing analysis tool.

The actual static timing analysis step is shown at process block 1614 in FIG. 16. This step may be performed in any suitable fashion and is preferably performed with a static timing analysis tool such as the PATHMILL software product by EPIC Design Technology. The static timing analysis is performed for the entire circuit under consideration, including all functional components which have been modeled according to the present invention as described above, and also including any other components which have not been so modeled. As indicated in FIG. 16, the static timing analysis requires access to the circuit schematic library for analysis involving portions of the circuit which have not been modeled according to the invention. The static timing analysis also requires access to the gray box library containing the models which have been produced according to the present invention.

This static timing analysis step shown at 1614 in FIG. 16 is performed as usual in the respective analysis tool except that the tool will use the timing models for the functional components which have been isolated from other components of the circuit according to step 1602 in FIG. 16. Thus, the static timing analysis tool does not have to perform the traditional device-by-device analysis that would otherwise be required for circuit elements included in the modeled functional components. This elimination of device-by-device analysis for complex portions of the circuit under consideration greatly reduces the processing burden on the static timing analysis tool. Yet the use of timing models does not diminish the accuracy of the analysis because the models themselves utilize timing information from actual circuit simulations, and thus may provide very accurate timing information. The result of the static timing analysis for the circuit step 1614 in FIG. 16 is an accurate model of the entire top level schematic for the circuit under consideration. This model may be used as a macro for the circuit which can be used with other models to perform a timing analysis for a full chip or unit (e.g. Floating point unit, load/store unit, etc.).

The above described preferred embodiments are intended to illustrate the principles of the invention, but not to limit the scope of the invention. Various other embodiments and modifications to these preferred embodiments may be made by those skilled in the art without departing from the scope of the following claims. For example, the invention is not limited to the particular timing elements described above for purposes of example. Also, the invention is not limited to analysis of particular types of circuits such as the register file circuit shown for purposes of example in FIGS. 11 through 13. It will also be appreciated that the particular functional components and timing determinant blocks described above in the example circuits are described only for purposes of illustrating the invention. The boundaries between functional components of an overall circuit and the boundaries between timing determinant blocks within functional components may be selected at the discretion of the designer according to any standard. Particularly, the functional components selected for modeling according to the invention may be as expansive or as limited as desired for the purposes of producing the desired model.

1. A method for analyzing an electronic circuit, the method comprising steps of:
(a) replacing at least one timing determinant block in a first functional component of the circuit with a timing element set;
(b) performing a circuit simulation for a cross-section of the first functional component to determine timing characteristics associated with each replaced timing determinant block of the first functional component;
(c) attaching the timing characteristics associated with each replaced timing determinant block to the respective timing element set which replaced the respective timing determinant block, thereby creating a timing model for the first functional component; and
(d) performing a static timing analysis for the circuit utilizing the timing model for the first functional component.

2. The method of claim 1 further comprising the step of:
(a) identifying an additional functional component from the circuit to be analyzed.

3. The method of claim 2 further comprising the steps of:
(a) replacing at least one timing determinant block in the additional functional component with an additional timing element set;
(b) performing a circuit simulation for a cross-section of the additional functional component to determine the timing characteristics associated with each replaced timing determinant block of the additional functional component;
(c) attaching the timing characteristics associated with each replaced timing determinant block of the additional functional component to the respective timing element set which replaced the respective timing determinant block, thereby creating a timing model for the additional functional component; and
(d) wherein the step of performing a static timing analysis for the circuit also utilizes the timing model for the additional functional component.

4. The method of claim 1 further including the step of:
(a) selecting the cross-section of the first functional component to produce a worst-case timing path through the functional component.

5. The method of claim 1 further including the step of:
(a) selecting the cross-section of the first functional component to produce a best-case timing path through the functional component.

6. The method of claim 1 further including the step of:
(a) developing a group of timing elements for use in producing timing element sets suitable for replacing a number of different timing determinant blocks.

7. The method of claim 1 wherein each timing determinant block in the first functional component is replaced with a respective timing element set.

8. A method of producing a timing model for use in static timing analysis for an electronic circuit, the method comprising the steps of:
(a) replacing at least one timing determinant block in a functional component of the circuit with a timing element set;
(b) performing a circuit simulation for a cross-section of the functional component to determine timing characteristics associated with each replaced timing determinant block of the functional component; and
(c) attaching the timing characteristics associated with each replaced timing determinant block to the respective timing element set which replaced the respective timing determinant block.

9. The method of claim 8 further including the step of:
(a) selecting the cross-section of the functional component to produce a worst-case timing path through the functional component.

10. The method of claim 8 further including the step of:
(a) selecting the cross-section of the first functional component to produce a best-case timing path through the functional component.

11. The method of claim 8 further including the step of:
(a) developing a group of timing elements for use in producing timing element sets suitable for replacing a number of different timing determinant blocks.

12. The method of claim 8 wherein each timing determinant block in the functional component is replaced with a respective timing element set.

13. The method of claim 8 wherein the cross-section for the circuit simulation is selected to provide information on a first signal path through the functional component and further including the step of performing a second circuit simulation for a different cross-section of the functional component to determine timing characteristics associated with each replaced timing determinant block of the functional component for that different cross-section.

14. A method for employing timing elements to create a timing model for a functional component of a circuit, the method comprising the steps of:
(a) defining a group of timing elements, each timing element in the group comprising an element for representing at least a portion of the timing characteristics associated with a timing determinant block within the functional component;
(b) replacing at least one timing determinant block in the functional component with a timing element set including one or more of the timing elements from the group of timing elements;
(c) performing a circuit simulation for a cross-section of the functional component to determine simulated timing characteristics associated with each replaced timing determinant block of the functional component; and
(d) attaching the simulated timing characteristics associated with each replaced timing determinant block to the respective timing element set which replaced the respective timing determinant block.

15. The method of claim 14 further including the step of:
(a) selecting the cross-section of the functional component to produce a worst-case timing path through the functional component.

16. The method of claim 14 further including the step of:
(a) selecting the cross-section of the first functional component to produce a best-case timing path through the functional component.

17. The method of claim 14 wherein each timing determinant block in the functional component is replaced with a respective timing element set.

18. The method of claim 14 wherein the cross-section for the circuit simulation is selected to provide information on a first signal path through the functional component and further including the step of performing a second circuit simulation for a different cross-section of the functional component to determine simulated timing characteristics associated with each replaced timing determinant block of the functional component for that different cross-section.
